(19) United States
(12) Patent Application Publication
(10) Pub. No.: US 2016/0013563 A1
(43) Pub. Date: Jan. 14, 2016

(54) Wideband Twin Beam Antenna Array

(71) Applicant: Commscope Technologies, LLC, Hickory, NC (US)

(72) Inventors: Igor E. TIMOFEEV, Dallas, TX (US); Gangyi DENG, Allen, TX (US)

(21) Appl. No.: 14/329,503

(22) Filed: Jul. 11, 2014

(51) Int. Cl. H01Q 21/00

(52) U.S. Cl. CPC H01Q 21/0075

(57) ABSTRACT

A wideband antenna includes a plurality of radiating elements arranged in an array and a feed network. The feed network includes at least one frequency dependent power divider for varying the amplitude of a signal provided to at least two of the plurality of radiating elements as a function of a frequency of a signal. The feed network may further comprise a plurality of inputs and the antenna may produce a plurality of beams. The frequency dependent divider may comprise a power divider having a first output and a second output, a 90° hybrid, having a first input coupled to the first output of the power divider, and a second input, and a delay line, coupled between the second output of the power divider and the second input of the 90° hybrid.

### RELATED APPLICATIONS

This application claims priority to U.S. Provisional Patent Application No. 61/845,616, filed Jul. 12, 2013 and titled “Wideband Twin Beam Antenna Array”, the entire disclosure of which is incorporated by reference.

### FIELD OF THE INVENTION

The present invention generally relates to radio communication. More particularly, the invention relates to wideband multi-beam antennas for cellular communication systems.

### BACKGROUND OF THE INVENTION

For common cellular applications where a given site has three sectors, each serviced by one antenna, each antenna usually has 65 degree azimuth Half Power Beamwidth (HPBW). Six sector cells may be employed at such sites to increase system capacity. Antennas with 33 degree and 45 degree HPBW are the most common for 6 sector applications. However, replacing three antennas with six antennas (each of which is 2 times wider than a common 65 degree antenna) is not a compact and low cost solution.

Dual-beam (or multi-beam antennas) may be used to reduce number of antennas on the tower. One key aspect of a multi-beam antenna is the beam forming network (BFN). An example of a known dual-beam antenna from prior art may be found in Encyclopedia for RF and Microwave engineering, 2005 John Wiley and Sons, pp. 335-339. In the known dual beam antenna, a two beam by two column (2×2) BFN is used. The main drawback of this prior art antenna is high levels of side and backlobes (about −10 dB), which is not acceptable for modern systems due high interference. Another drawback is poor coverage: more than 50% of radiated power is wasted out of the desired two 60 degree sectors.

Another dual-beam prior art solution may be found in U.S. Pat. No. 8,237,619. This example includes a three column array. However, it also has very high sidelobes (about −9 dB) and relatively narrow operational band (1.7-2.1 GHz). In modem telecommunication systems it is desirable to include the LTE 2.6 GHz band, and a cover a bandwidth of 1.69-2.69 GHz, which is about 2.5 times wider bandwidth than in known solutions.

Another dual-beam prior art solution is U.S. Patent Pub. No. 2011/0205119, which is incorporated by reference. In the '119 application, improved azimuth suppression and wideband operation is achieved by including different antenna sub-arrays into an antenna array. For example, the antenna may include a two beam by three column array and a two beam by two column array. However, bandwidth is also limited for this prior art solution.

Consequently, there is a need to provide an improved antenna, with more consistent HPBW across a wider frequency bandwidth, better azimuth sidelobe suppression, with better coverage of desired sector and less interference with other sectors.

### SUMMARY OF THE INVENTION

In one example, a Frequency Dependent Divider (FDD) is included in the beam forming network for wideband beam forming and creation of frequency reconfigurable antennas. The FDD, integrated in the beam forming network, provides for changes in amplitude distribution on array elements with respect to frequency.

The FDD may be configured to change the power ratio on its outputs with respect to frequency. For example, for lowest frequency, all power goes to port 1, for highest frequency all power goes to port 2, and for central frequency power is about equal for both ports of FDD. In one aspect of the invention, a new compact frequency-dependent divider is proposed, comprising 3 dB divider, 90 degree hybrid and delay line between them. But other schemes of FDD (for example, filters) may be used.

In another aspect of invention, a combination of 4 element and 5 element linear arrays is used to create a dual beam antenna with stabilized HPBW (+/−2 degree from nominal in 1.7 to 2.7 GHz), stabilized beam position (+/−1 degree from nominal) with low sidelobe level in azimuth an elevation plane for both beams.

According to one aspect of the invention, a wideband antenna includes a plurality of radiating elements arranged in an array and a feed network. The feed network has at least one input and a plurality of outputs coupled to the plurality of radiating elements. The feed network further includes at least one frequency dependent power divider for varying the amplitude of a signal provided to at least two of the plurality of radiating elements as a function of a frequency of a signal. In one example, the feed network increasingly tapers a power distribution to radiating elements at each end of the wideband array as a function of increasing frequency. Other power distribution schemes may also be advantageous and are described in the detailed description and drawings.

In another example, the feed network further comprises a plurality of inputs and the antenna produces a plurality of beams. For example, the feed network may further include a 90° hybrid having two inputs and the antenna produces two beams.

The frequency dependent divider may comprise a power divider having a first output and a second output, a 90° hybrid, having a first input coupled to the first output of the power divider, and a second input, and a delay line, coupled between the second output of the power divider and the second input of the 90° hybrid. The delay line may be a regular transmission line, a regular transmission line combined with a Shiffman phase shifter, a transmission line incorporating a series inductances and parallel capacitors, or other suitable structure.

In one example, a dual beam wideband array is provided. The array includes at least first, second and third radiating elements, the first, second and third radiating elements. A 90° hybrid having a first beam input and a second beam input is included. The 90° hybrid has a first output and a second output, the second output being coupled to the first radiating element. The array further includes a first frequency dependent power divider having an input coupled to the first output of the first 90° hybrid and a first output coupled to the second radiating element and a second output coupled to the third radiating element. The second output of the frequency dependent power divider is coupled to the third radiating element.

In one example, the dual beam wideband array consists of three radiating elements, and the second and third radiating elements are at opposite ends of the array. In another example, the dual beam wideband array consists of four radiating elements, and the second and third radiating elements are at one end of the array. In another example, The dual beam wideband array further includes a second frequency-dependent divider and a power divider coupling the first output of the 90° hybrid to the respective inputs of the first and second frequency dependent dividers, and the array further comprises a fourth radiating element and a fifth radiating element. The second frequency dependent divider is coupled to fourth and fifth radiating elements.

### BRIEF DESCRIPTION OF THE DRAWINGS

FIG. 1A is schematic diagram of a wideband beam forming network and array according to one aspect of the present invention.

FIG. 1B illustrates a simulated radiation pattern of one beam produced by the beam forming network and array of FIG. 1A.

FIG. 2A is schematic diagram of another example of a beam forming network and array according to another aspect of the present invention.

FIG. 2B illustrates a simulated radiation pattern one beam produced by the network illustrated in FIG. 2A.

FIG. 3A is schematic diagram of another example of a beam forming network and array according to another aspect of the present invention.

FIG. 3B illustrates a simulated radiation pattern of one beam produced by the beam forming network and array illustrated in FIG. 3A.

FIG. 3C illustrates simulated radiation patterns for two beams produced by the beam forming network and array illustrated in FIG. 3A.

FIG. 4A illustrates a first example of a delay line according to one aspect of the present invention.

FIG. 4B illustrates a second example of a delay line according to one aspect of the present invention.

FIG. 4C illustrates a third example of a delay line according to one aspect of the present invention.

FIG. 5A illustrates a first example of how beam forming networks according to the present invention and having different numbers of radiating elements may be combined in an antenna array.

FIG. 5B illustrates a second example of how beam forming networks according to the present invention and having different numbers of radiating elements may be combined in an antenna array.

FIG. 5C illustrates a third example of how beam forming networks according to the present invention and having different numbers of radiating elements may be combined in an antenna array.

FIG. 5D illustrates a fourth example of how beam forming networks according to the present invention and having different numbers of radiating elements may be combined in an antenna array.

### DETAILED DESCRIPTION

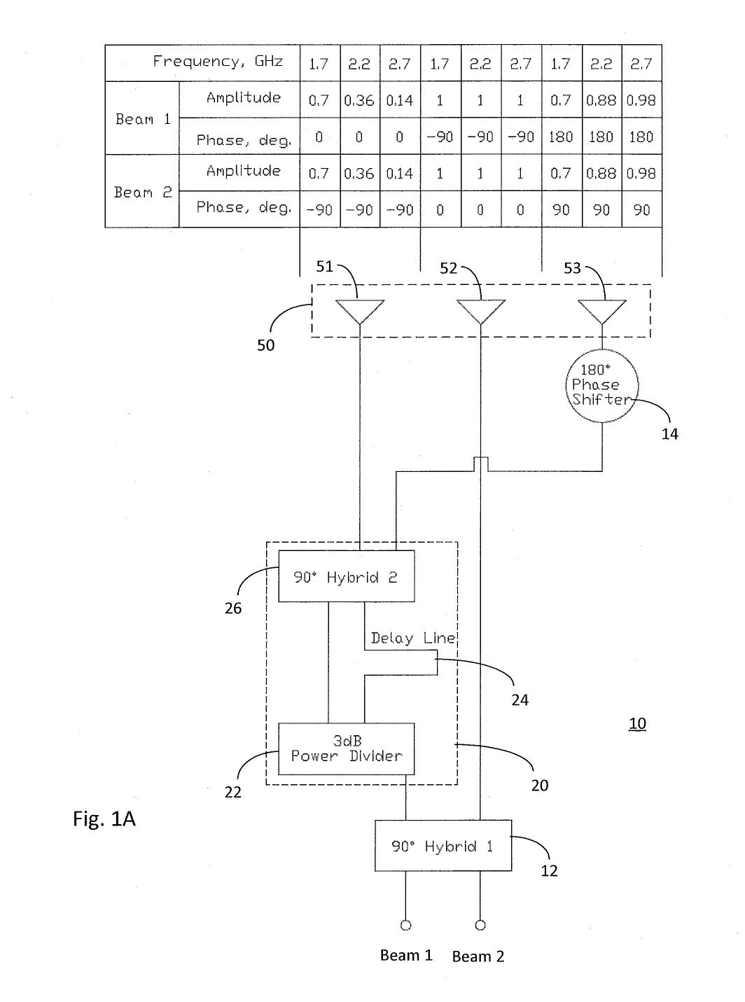

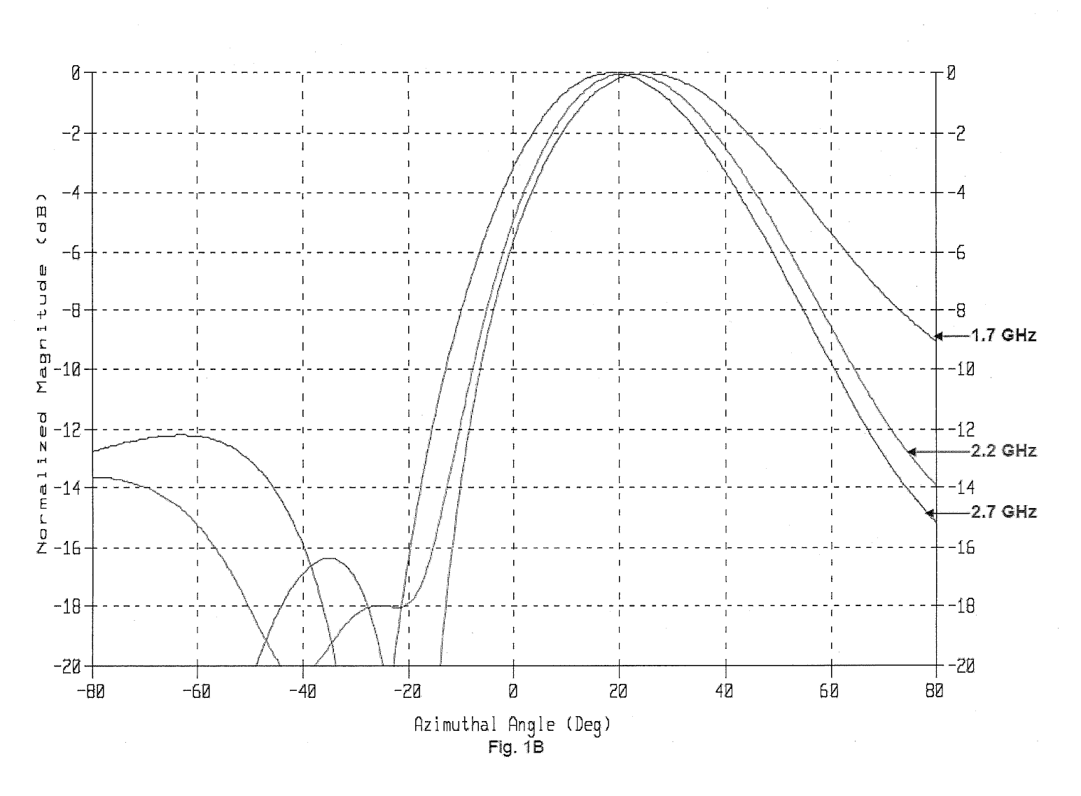

One aspect of the present invention is to compensate for the array factor of a phased-array multi-beam antenna with changing frequency. For example, FIG. 1A shows schematic diagram of beam forming network 10 and an array 50 of three radiating elements 51, 52 and 53. This example accepts two inputs, Beam 1 and Beam 2, and produces two beams. The beam forming network 10 comprises a 90° hybrid 12, a frequency dependent divider 20, and a 180° phase shifter 14. Inputs Beam 1 and Beam 2 are input to 90° hybrid 12. A first output of hybrid 12 is coupled to the frequency dependent divider 20. A second output of hybrid 12 is coupled to a middle radiating element 52 of the array 50. Hybrid 12 may comprise a commercially available wideband 90° hybrids, for example Anaren X3C17-03WS-CT, which as a bandwidth of 690-2700 MHz, with almost constant 90° shift over all frequency band. The 3 dB power dividers, 16, 22 may be a multi-section Wilkinson dividers.

The frequency dependent divider 20 comprises a power divider 22, a delay line 24, and a 90° hybrid 26. The power divider 22 splits the signal from the first output of hybrid 12 into two signals. In this example, the power division of power divider 22 is equal. A first output of the power divider 22 is coupled to a first input of hybrid 26. A second output of the power divider 22 is coupled to the delay line 24. The output of delay line 24 is coupled to a second input of hybrid 26.

A first output of the frequency dependent divider 20 is coupled to radiating element 51. In this example, radiating element 51 is the first element in the array 50. The second output of the frequency dependent divider 20 is coupled to the third element of the array 50, radiating element 53, via 180° phase shifter 14. While 180° phase shifter 14 may be implemented as a discrete component, 180° phase shifter 14 may also be implemented by using a dipole radiator for the radiating element, and alternating the feedpoint relative to the other dipole elements.

Referring to the frequency dependent divider 20, the delay line 24 imposes a phase delay to a signal which coupled to the second input of hybrid 26. However, if the delay line is a fixed length, the phase delay experienced by a signal varies with frequency. That is, for a given fixed time delay, higher-frequency signals experience more phase delay than low frequency signals. Hybrid 26, therefore, receives equal amplitude signals, where the signals to one input experience increasing phase delay with increasing frequency. Hybrid 26 outputs equal phase, variable amplitude signals, where the amount of amplitude difference increases with increasing frequency.

With proper selection of delay line 24, HPBW can be stabilized over a desired frequency band. For example, amplitude ratio between outputs of the frequency dependent divider 20 (and the first and third radiating elements, 51, 52, of array 50) may be written as:

A1/A3=[(1−sinφ)/(1+sinφ)]½

Or, P1/P3=10log [(1−sinφ)/(1+sinφ)] [dB], where φ is electrical length of delay line. When φ=0° or 180°, both elements have the same amplitude. When φ=90° or 270°, one element has 0 amplitude, and another one amplitude 1.

In the example of FIG. 1A, the frequency dependent divider 20 is placed between radiating elements 51 and 53. The delay line is selected to be a regular transmission line with an electrical length of 180° for 1.7 GHz. For other frequencies y=233° for 2.2 GHz; 286° for 2.7 GHz. For both Beam 1 and Beam 2, beam forming network 10 provides a power distribution at radiating elements 51, 52 and 53, respectively, of 0.7, 1, and 0.7 at 1.7 GHz, 0.36, 1 and 0.88 at 2.2 GHz, and 0.14, 1 and 0.98 at 2.7 GHz. Beam forming network 10 also provides 90° phase differences between radiating elements to create two beams.

For FIG. 1B, results of a simulation of radiating patterns for one beam at three frequencies are shown. Spacing between elements for this example is selected at 80 mm and 60 mm. As one can see from FIG. 1B, HPBW is stabilized to 41+/−3° in this example.

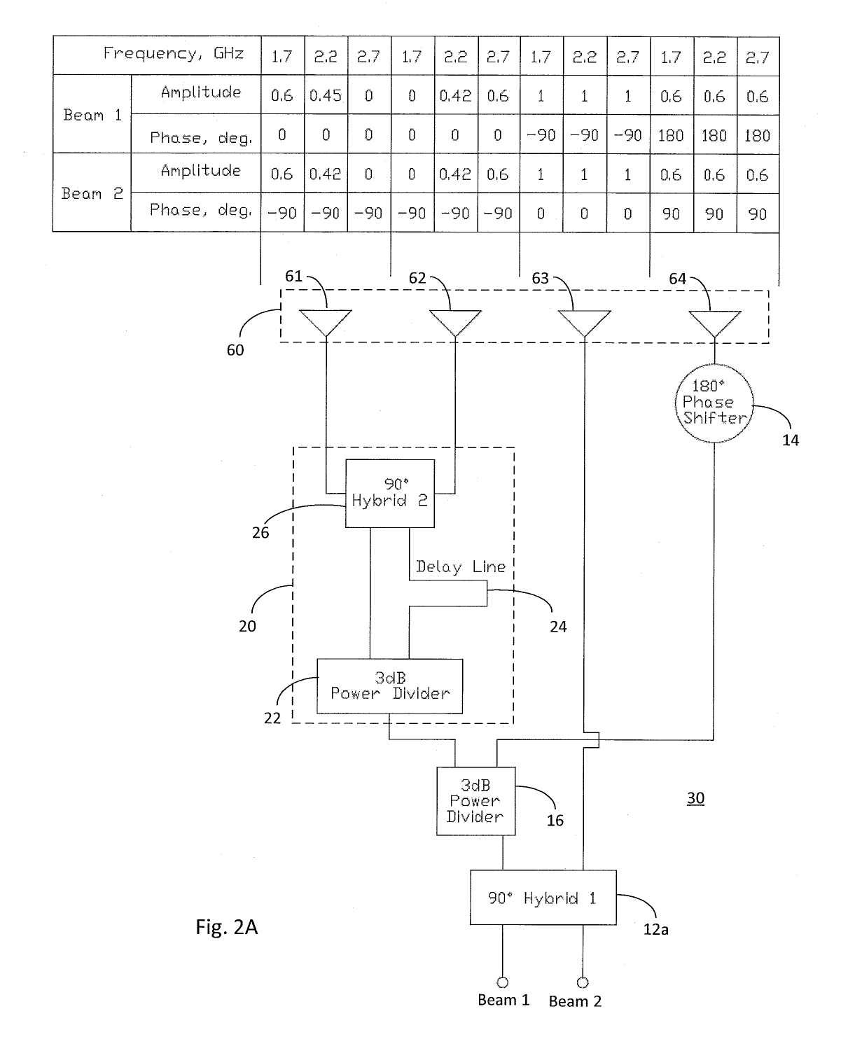

Another aspect of the present invention is to compensate for the array factor and radiating element patters of a phased-array multi-beam antenna with changing frequency. For example, FIG. 2A illustrates a schematic diagram of another example of the present invention. Beam forming network 30 produces two beams via array 60 comprising radiating elements 61-64. Beam Forming Network 30 comprises a 90° hybrid 12a, or power divider 16, a frequency dependent divider 20, and 180° phase shifter 14. Hybrid 12a may comprise a non-equal 90° hybrid 1 (−3.8 dB, −2.4 dB) for improved sidelobe suppression.

Beam 1 and Beam 2 signals are input to hybrid 12a. A first output of hybrid 12a is coupled to power divider 16. A second output of hybrid 12a is coupled to radiating element 63 (the third radiating element of array 60). A first output of power divider 16 is coupled to frequency dependent divider 20. The first and second outputs of frequency dependent divider 20 are coupled to radiating elements 61 and 62 of array 60, respectively (the first and second elements of array 60). A second output of power divider 16 is coupled to 180° phase shifter 14, which is in turn coupled to radiating element 64.

In this example, the power tapering is frequency dependent for radiating elements 61 and 62, and not frequency dependent for radiating elements 63 and 64. In particular, in this example, delay line 24 is selected to have φ=270° for 1.7 GHz and 450° for 2.7 GHz. Amplitude and phase distribution is shown in FIG. 2A (above the radiating elements). In this example, the amplitude distribution at 1.7 GHz is 0.6, 0, 1, and 0.6 at radiating elements 61, 62, 63 and 64, respectively. Similarly, the amplitude distribution at 2.2 GHz is 0.45, 0.42, 1 and 0.6, and the amplitude distribution at 2.7 GHz is 0, 0.6, 1 and 0.6. Accordingly, at 1.7 GHz elements 1, 3, 4 are radiating, at 2.2 GHz all four elements are radiating, and at 2.7 GHz, elements 2, 3, 4 are radiating. That is, beam forming network 30, by reducing amplitude effectively to zero for some radiating elements at certain frequencies, effectively reconfigures Array 60 on a frequency-dependent basis. This feature of frequency re-configurability allows to stabilize beam width and beam position for both beams.

Calculated radiation patterns are shown in FIG. 2B for 1.7, 2.2, 2.7 GHz (for one beam). As one can see from FIG. 2B, not only is HPBW is stabilized (36+/−4°), but also beam position is stabilized (21.5+/−1.5).

In another embodiment, all radiating elements of the Array 60 may be continue to be driven, but at different amplitudes at different frequencies. For example, at low frequency of operational bandwidth, central and periphery elements have almost the same amplitude (for example, 0.75; 1; 1; 0.75). For highest frequency of operational bandwidth, periphery elements have much lower amplitude (for example, 0.2; 1; 1; 0.2).

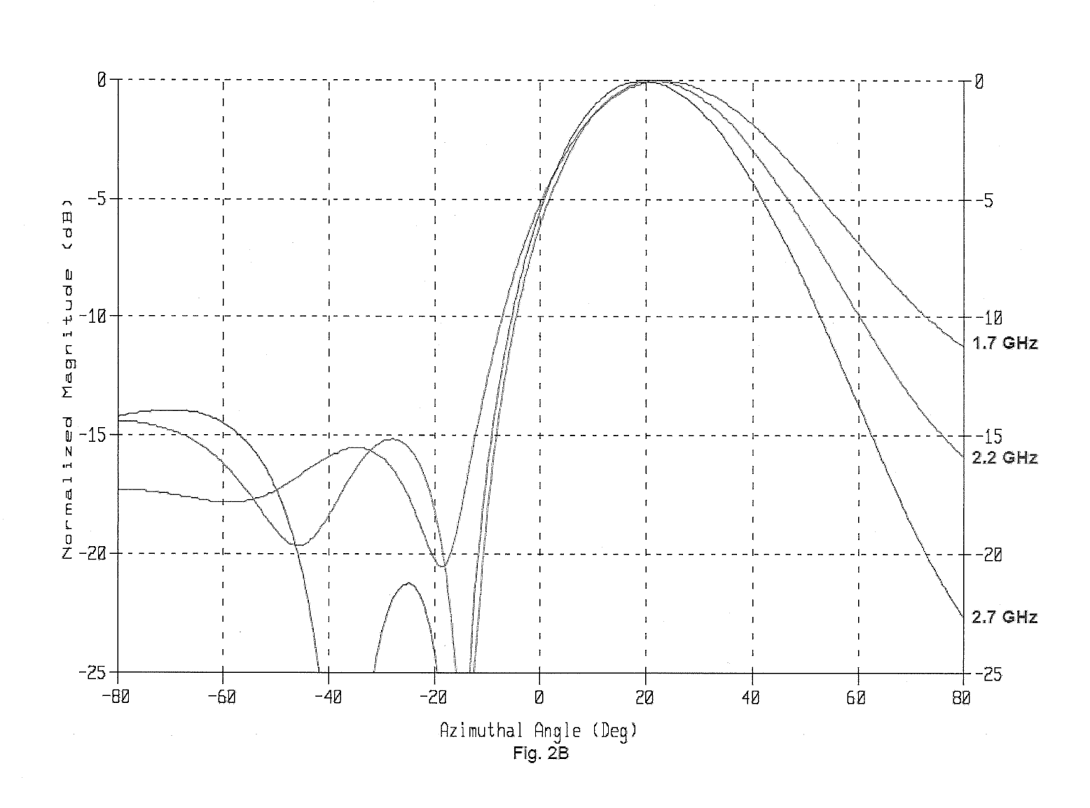

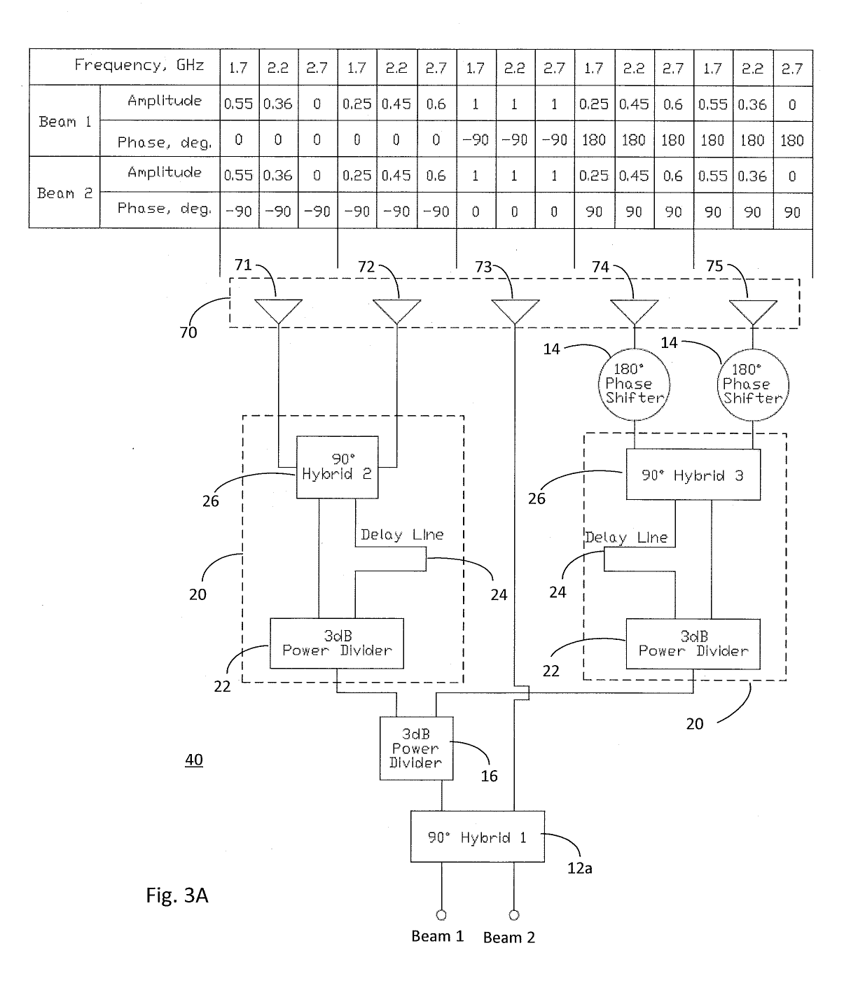

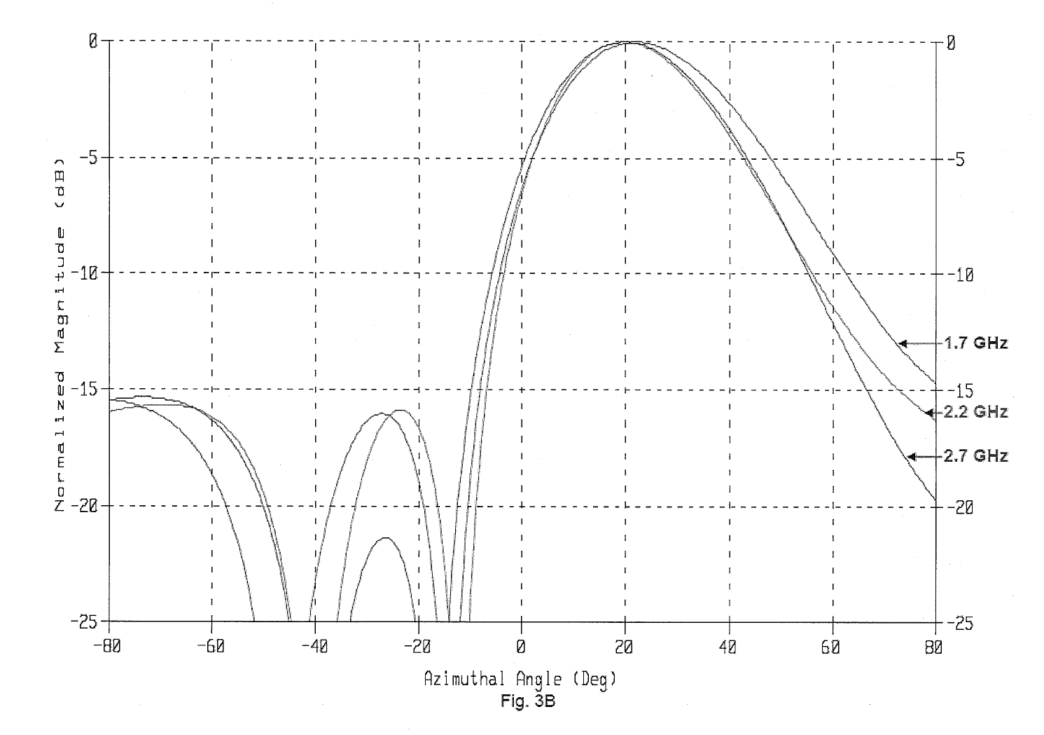

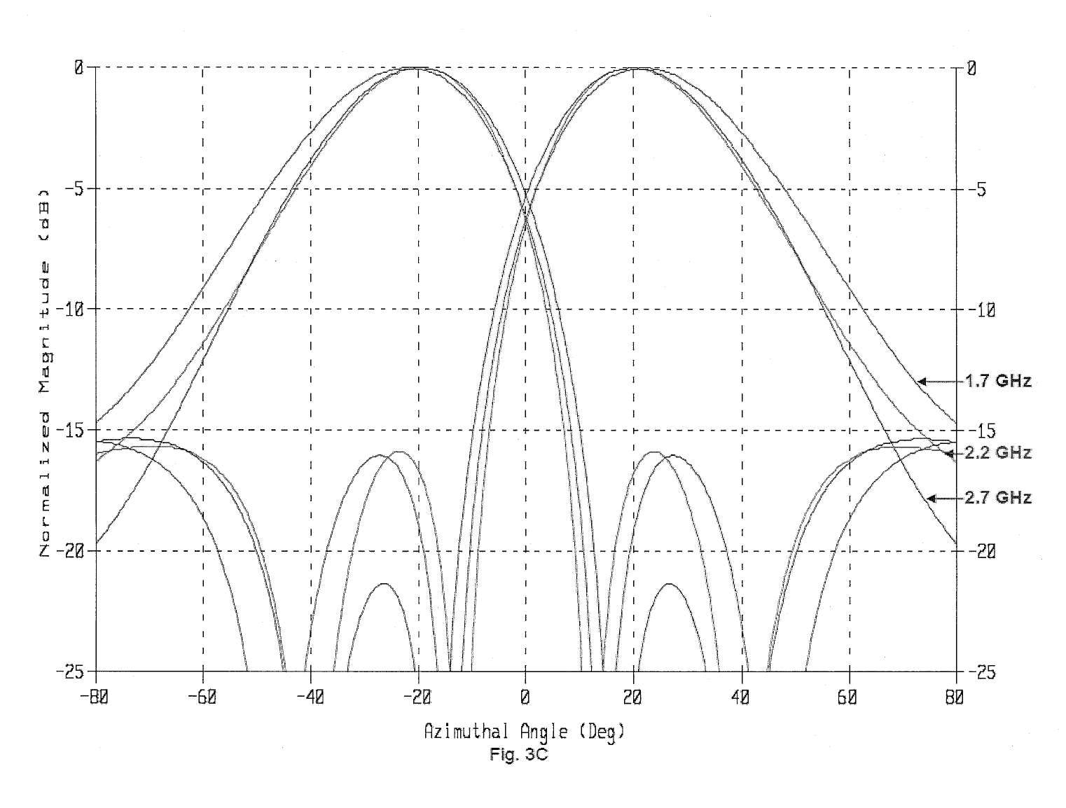

FIG. 3A illustrates a schematic diagram of another example of the present invention. Beam forming network 40 produces two beams via array 70 comprising radiating elements 71-75. Beam forming network 40 comprises a 90° hybrid 12a, a power divider 16, two frequency dependent dividers 20, and two 180° phase shifters 14. Beam 1 and Beam 2 signals are input to hybrid 12a. A first output of hybrid 12a is coupled to power divider 16. A second output of hybrid 12a is coupled to radiating element 73 (the third radiating element of array 70). A first output of power divider 16 is coupled to a first frequency dependent divider 20. A second output of power divider 16 is coupled to a second frequency dependent divider 20. The first and second outputs of the first frequency dependent divider 20 are coupled to radiating elements 71 and 72 of array 70, respectively (the first and second elements of array 60). The first and second outputs of the second frequency dependent divider 20 are coupled to radiating elements 74 and 75 of array 70, respectively (the fourth and fifth elements of array 70).

The delay line 24 for both frequency dependent dividers 20 in this example comprises a transmission line with φ=283° at 1.7 GHz, 366° at 2.2 GHz, 450° at 2.7 GHz. For example, delay line 24 may comprise 50 Ohm microstrip line with ε=3 and d=85 mm. Spacing between elements for this example is selected 8.0 mm and 60 mm. Hybrid 12a may comprise a non-equal 90° hybrid 12a (−3.8 dB, −2.4 dB) for improved sidelobe suppression (<−16 dB in this example).

Amplitude and phase distribution is shown in FIG. 3A (above the radiating elements), and calculated patterns are shown in FIG. 3B for 1.7, 2.2 and 2.7 GHz (for one beam) and in FIG. 3C (for both beams). In this example, at 1.7 GHz, the amplitude distribution is 0.55, 0.25, 1, 0.25, and 0.55 for radiating elements 71, 72, 73, 74, 75, respectively. Similarly, the amplitude distribution at 2.2 GHz is 0.36, 0.45, 1, 0.45 and 0.36, and the amplitude distribution at 2.7 GHz is 0, 0.6, 1, 0.6 and 0.

For low frequency (1.7 GHz), radiating elements 71, 73, and 75 are handling the most radio frequency energy. For mid-frequency (2.2 GHz), radiating elements 72, 73, 74 are handling the most radio frequency energy. For high frequency (2.7 GHz), radiating elements 72, 73 and 75 are handling all of the radio frequency energy, and radiating elements 71 and 75 are not radiating. Accordingly, this is another example of a frequency reconfigurable antenna. By selectively using different radiating elements at different frequencies, the effective aperture of array 70 is changing proportional to wavelength for both beams, providing almost constant HPBW and beam position angle.

The example of FIG. 3A is more complicated relative to the examples of FIG. 1A and FIG. 2A, but constant HPBW over wide (50%) bandwidth, constant beam position and low sidelobe level constitutes an improvement over the prior art. For example, HPBW and beam position are very stable: 34+/−2° and 21+/−1°, respectively. The beam width and beam position tolerances are about 10 times better than in prior art (U.S. Pat. No. 8,237,619, FIG. 2, FIG. 3: HPBW=40+/−7° and beam position 20+/−4° for twice less frequency band, 1.7-2.2 GHz only with high sidelobes (−9 dB).

In the above examples, beam forming networks were shown for 1.7-2.7 GHz, but the invention is not limited to this frequency band and may be implemented using any other frequencies.

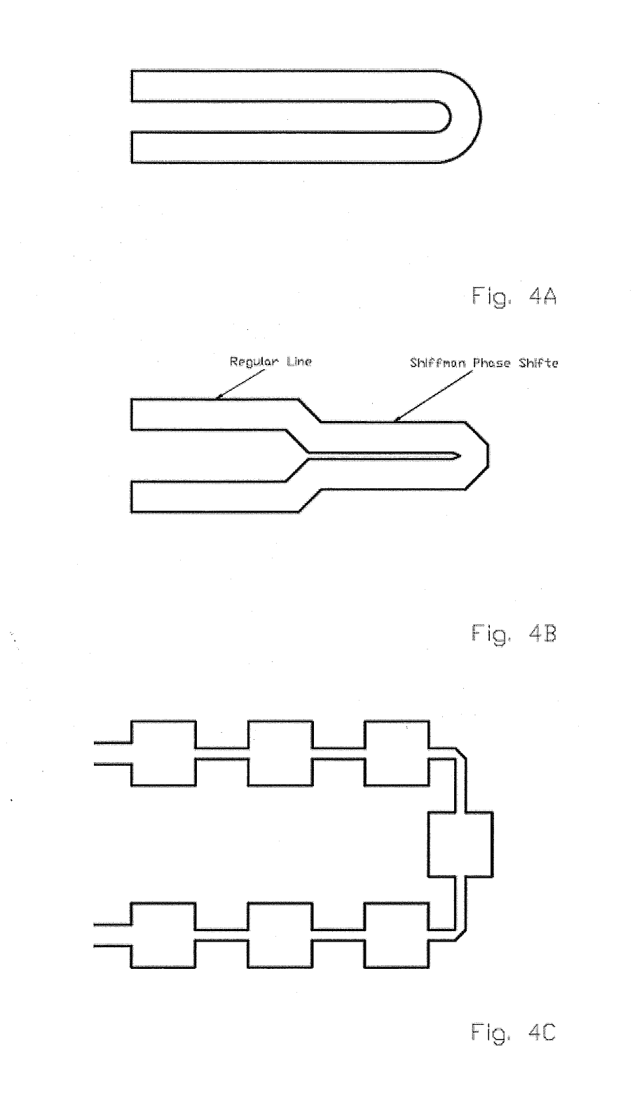

Various delay line 24 may be advantageous in various applications. For example, FIGS. 4A, 4B and 4C illustrate three different variations of delay lines. FIG. 4A illustrates a regular transmission line, where phase delay is directly proportional to frequency. For example, it can be 50 Ohm microstrip line with length d, and φ=[2π(εe½)]/λ, where εe—effective dielectric constant of substrate material. This line may be used for the example illustrated in FIG. 1A (φ=180° 1.7) GHz and for FIG. 3 (φ=283° GHz 1.7).

FIG. 4B illustrates a delay line comprising a regular transmission line combined with a Shiffman phase shifter. Because a Shiffman phase shifter provides constant phase over frequency band, phase for this delay line will change more slowly with frequency compared to a regular transmission line as illustrated in FIG. 4A.

FIG. 4C shows a loaded line, where narrow sections (series inductances) are combined with wide sections (parallel capacitances), providing 15-30% “faster” phase change compare to regular line. The example of FIG. 4C may be used, for example, to create amplitude distribution shown in the example of FIG. 2A: φ(1.7 GHz)=270° and φ(2.7 GHz)=450°.

By using different style of delay line, it is possible to provide desirable dependence of amplitude distribution against frequency, and get optimization of beam position, beam width and sidelobes.

Wideband 180° phase shifter 14 may be easy realized with dipole radiator, by alternating feedpoint (for 0°, central conductor of feed line is connected to 1^{st} dipole arm, for 180° , it is connected to 2^{nd} dipole arm). This solution provides constant 180° phase shift over whole frequency band without having to add a discrete phase shifter component.

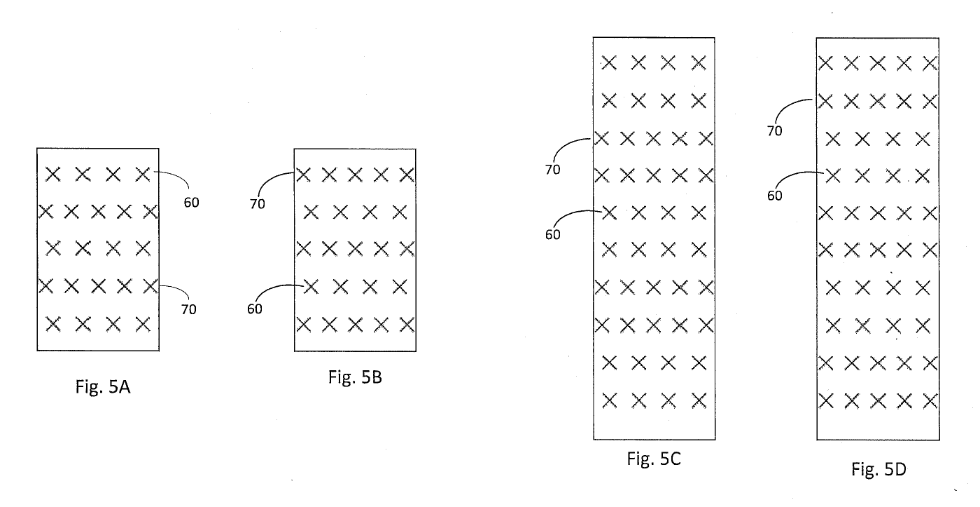

In a full array, a combination of 3, 4 and 5 element linear arrays as described in FIGS. 1A, 2A, 3A may be implemented. Such combinations may be advantageously used to reduce azimuth sidelobe level. For example, FIGS. 5A and 5B illustrate alternating five element arrays 70 and four element arrays 60. FIGS. 5C and 5D illustrate alternating pairs of five element arrays 70 and four element arrays 60. Also, for further sidelobes' and beam shape optimization, horizontal spacing between elements can also be different. Examples shown in FIG. 5 are related to antennas with +/−45 degree dual polarization (most common in base station antenna technology), but of course the same solutions can be applied to antennas with any single or dual polarization.

What is claimed is:

1. A wideband antenna, comprising:
a plurality of radiating elements arranged in an array; and
a feed network having at least one input and a plurality of outputs coupled to the plurality of radiating elements, the feed network further comprising at least one frequency dependent power divider;
wherein the frequency dependent power divider varies the amplitude of a signal provided to at least two of the plurality of radiating elements as a function of a frequency of a signal.

2. The wideband array of claim 1, wherein the feed network increasingly tapers a power distribution to radiating elements at each end of the wideband array as a function of increasing frequency.

3. The wideband antenna of claim 1, wherein the feed network further comprises a plurality of inputs and the antenna produces a plurality of beams.

4. The wideband antenna of claim 1, wherein the feed network further comprises a 90° hybrid having two inputs and the antenna produces two beams.

5. The wideband antenna of claim 1, wherein the frequency dependent divider comprises:
a. a power divider having a first output and a second output;
b. a 90° hybrid, having a first input coupled to the first output of the power divider, and a second input; and
c. a delay line, coupled between the second output of the power divider and the second input of the 90° hybrid.

6. The wideband antenna of claim 5, wherein the delay line is a regular transmission line.

7. The wideband antenna of claim 5, wherein the delay line is a regular transmission line combined with a Shiffman phase shifter.

8. The wideband antenna of claim 5, wherein the delay line incorporates series inductances and parallel capacitors.

9. A dual beam wideband array, comprising:
a. at least first, second and third radiating elements, the first, second and third radiating elements comprising an array;
b. a 90° hybrid having a first beam input and a second beam input, the 90° hybrid further having a first output and a second output, the second output being coupled to the first radiating element; and
c. a first frequency dependent power divider having an input coupled to the first output of the first 90° hybrid and a first output coupled to the second radiating element and a second output coupled to the third radiating element.

10. The dual beam wideband array of claim 9, wherein the array consists of three radiating elements, the second and third radiating elements being located at opposite ends of the array, and the second output of the first frequency dependent power divider is coupled to the third radiating element with a 180° phase shift.

11. The dual beam wideband array of claim 9, wherein the array consists of four radiating elements, and the second and third radiating elements are at one end of the array.

12. The dual beam wideband array of claim 9 further comprising a second frequency-dependent divider and a power divider coupling the first output of the 90° hybrid to the respective inputs of the first and second frequency dependent dividers, and the array further comprises a fourth radiating element and a fifth radiating element, wherein the second frequency dependent divider is coupled to fourth and fifth radiating elements with a 180° phase shifts.

13. The dual beam wideband array of claim 9, wherein the frequency-dependent divider comprises a power divider, a delay line and a 90 degree hybrid.

14. The dual beam wideband array of claim 9, where spacing between radiators are not equal.

15. The dual beam wideband array of claim 10, further comprising a plurality of arrays having different numbers of radiating elements.
